(19) United States
(12) Patent Application Publication
(10) Pub. No.: US 2022/0342489 A1
(43) Pub. Date: Oct. 27, 2022

(54) Machine learning user motion identification using intra-body optical signals

(71) Applicant: The Board of Trustees of the Leland Stanford Junior University, Stanford, CA (US)

(72) Inventors: Tyler Chen, Carlsbad, CA (US); Savannah Cofer, Lewis Center, OH (US)

(21) Appl. No.: 17/728,616

(22) Filed: Apr. 25, 2022

Related U.S. Application Data
(60) Provisional application No. 63/179,351, filed on Apr. 25, 2021.

(51) Int. Cl. G06F 3/03; G06T 7/20; G06F 3/01

(52) U.S. Cl. CPC G06F 3/0304; G06T 7/20; G06F 3/017

(57) ABSTRACT

Machine learning for optically identifying user motions is provided. An optical path is formed as light travels through a portion of the user's body and is sampled by optical sensors to form a set of signals which vary as a function of the user's tissue configuration in the optical path. These signals are preprocessed at least by suppressing signal baselines in real-time during operation, which allows for improved low-latency detection of user motions via a trained statistical model which is more robust to variability in optical paths and tissue configuration.

### CROSS REFERENCE TO RELATED APPLICATIONS

This application claims priority from U.S. Provisional Patent Application 63/179,351 filed Apr. 25, 2021, which is incorporated herein by reference.

### GOVERNMENT SPONSORSHIP

None.

### FIELD OF THE INVENTION

This invention relates to machine learning for identification of user motions using optical sensors.

### BACKGROUND

Machine learning is often applied to pattern recognition problems, such as recognizing user inputs via touch and/or gestures. One sensor modality that has been used in this context is optical, where optical signals propagate though part of the user's body to provide the required data, as opposed to using a camera to obtain images showing the user motion. However, we have found that standard machine language preprocessing (e.g., scaling raw data to a 0 to 1 range, etc.) is not sufficient to lead to good results for touch/gesture identification in this context, especially in cases where the model is required to be robust across multiple users and/or multiple sessions. Accordingly, it would be an advance in the art to provide improved machine learning for touch/gestures using intra-body optical signals.

### SUMMARY

This work relates to methods of optically identifying user motions, where an optical path is formed as light travels through a portion of the user's body tissue and is sampled by optical sensors to form a set of signals which vary as a function of the user's tissue configuration in the optical path. These signals are preprocessed by at least by suppressing signal baselines in real-time during operation, which allows for accurate, sensitive, and specific low-latency detection of user motions via a trained statistical model which is more robust to variability in optical paths and tissue configuration.

In some embodiments, a wearable electronic device with optical emitters and sensors may be used to achieve this—in some cases using dynamic adjustment of sensor baselines to optimize the conditions for detection of user motions. In some embodiments, contextual data may be used to augment the performance of this method by using a different preprocessing method, a different configuration of input light sources and light sensors, and/or a different trained statistical model, depending on the context. In some embodiments, contextual and other data may also be used as further inputs to the statistical model. In some examples pertaining to detecting motions of the hand, the method may further utilize sensor information or prior knowledge to identify whether the user is grasping an object, contacting their hand to a surface, or holding their hand in free space, and use this contextual data to select which trained statistical model is used to identify user motions.

In one example, if a user of a wrist worn device employing this method rests their hands on a surface in a position indicative of typing on a keyboard, the method could use this contextual data to select a trained statistical model to identify user finger motions on the surface and transmit motions as keystrokes.

In one example, if the user holds a hand in the air, the method may identify this and utilize a model to identify and transmit the user's hand pose to an external device.

### BRIEF DESCRIPTION OF THE DRAWINGS

FIGS. 1A-B show an exemplary embodiment of the invention.

FIG. 2 shows an example of optical paths passing through the user's body.

FIGS. 3A-D show examples of output optical signals with and without baseline removal.

FIGS. 4A-C illustrate output light signals and their representative gesture identification results from a trained statistical model.

FIG. 5 shows an exemplary embodiment having a wristband on which optical sources and detectors are mounted.

FIG. 6 shows an example of hand joints, some or all of which can be included in a hand pose model.

FIGS. 7A-B show two examples for how to make use of additional context data to improve user motion identification.

FIGS. 8A-B show an example of how time-division multiplexing can be implemented to increase the number of optical paths that are sampled.

FIG. 9 shows an approach for user identification relying on principles of the invention.

### DETAILED DESCRIPTION

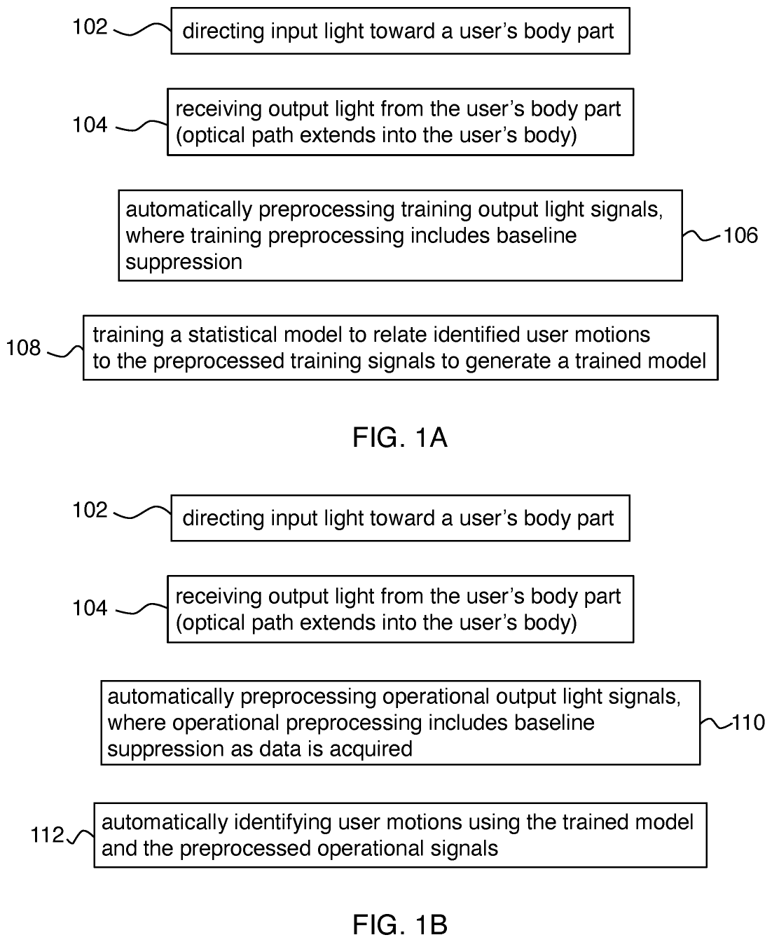

FIGS. 1A-B show an exemplary embodiment of the invention. This example is a machine learning method of identifying user motions performed by a user. FIG. 1A shows the steps for training, and FIG. 1B shows the steps for operation. Here training has its usual machine learning meaning of training a model with data including at least data collected from one or more users, and optionally simulated data inputs and/or adversarial training inputs to improve model performance.

Step 102 is directing input light toward a part of the user's body. Step 104 is receiving output light that is caused by the input light from the part of the user's body. Here an optical path from the input light to the output light extends into the user's body, as described in greater detail below. Step 106 is automatically preprocessing one or more training output light signals with a training preprocessing method to generate corresponding preprocessed training signals. Here the training preprocessing method includes baseline suppression. This baseline suppression can be done as data is acquired (i.e., the baseline is removed in real time as data is gathered), or it can be applied to the training data after that data set is complete (i.e., batch mode). Any combination of real time and batch mode baseline removal can be done. Step 108 is training a statistical model to relate identified user motions to the preprocessed training signals to generate a trained model. Here automatically has its usual meaning of proceeding under computer control without ongoing human input or control. An optical path is any path that is taken by light from a source to a detector.

During operation (FIG. 1B) steps 102 and 104 are as described above. Step 110 is automatically preprocessing one or more operational output light signals with an operational preprocessing method to generate corresponding preprocessed operational signals. This baseline suppression is done as data is acquired (i.e., during operation, the baseline is removed in real time as data is gathered). Thus, baseline removal is done both in training and during operation, but the training and operational preprocessing methods can be the same or they can be different. One way they can differ is that the training preprocessing method can be done in batch mode, as indicated above. Preferably, the training and operational preprocessing methods are the same or at least implement the same algorithm (e.g. with a real-time vs. batch mode difference). Step 112 is automatically identifying user motions using the trained model and the preprocessed operational signals.

Baseline suppression in training and/or operation can include subtracting a moving average to generate the preprocessed signal. For example, the moving average of the signal at time t can be computed by averaging the signal over a time range from t−Δt to t, where Δt is in a range from 1 millisecond to 10 seconds. The baseline suppression in training and/or operation can also include subtracting a periodic waveform generated by the user's heartbeat. For multiple channels, each channel can have its own baseline removed from it. In other cases, different baselines can be removed from each channel.

Baseline removal can also be done “in hardware” instead of by signal processing. For example, circuit components may be arranged such that signal baselines are automatically removed before output data acquisition. One or more receiver baselines can also be adjusted as data is received by modifying input light intensity and/or receiver sensitivity, based on parameters such as: optical path length, output light intensity, and computed baseline value. Baseline removal can also be done in any combination of hardware and software, provided the suppression of operational baselines is done in real time as the data is acquired. In some embodiments, baseline values can be computed by using data from other sensors, such as a force sensor. In some embodiments, baseline removal includes subtraction of a moving average, where samples are excluded from the moving average if they meet certain criteria. In some embodiments, the exclusion criteria are based on the signal intensity or its derivative. In some embodiments, the exclusion criteria are based on the other events occurring concurrently with the output light signal acquisition, such as vibration of a haptic motor.

Once a user motion is identified, further steps can be taken, such as automatically providing feedback to the user and/or selecting and executing a command. Here the command that is selected depends on the user motion that is identified. Optionally, other contextual factors can also be used for this determination. For example, contextual factors may include the arrangement of the user's real or virtual surroundings, the user's body pose, the state of an electronic device, or past user interactions.

A perturbation can be added to the training output light signals prior to the training the statistical model to improve robustness of the trained model. Suitable perturbations include additive noise and signal amplitude modulation. Such modulation can be random or deterministic.

The user motions can be free space gestures. Here a free space gesture is any motion made by a user that doesn't make contact with any object or surface. Free space gestures can be distinguished from each other by one or more characteristics such as: gesture pattern, part of the user's body performing the gesture, duration, location, orientation, directionality, and muscle force. As used herein, gesture pattern refers to a repeatable motion made by a user. Gesture patterns may also be distinguished by temporal elements, such as performing multiple quick motions in sequence. An exemplary free-space hand gesture is a pointer finger flexion. Another exemplary free-space hand gesture is a wrist rotation while opening the fingers of the hand in a “shooing” motion.

The user motions can be touch gestures made by touching a surface. Here a touch gesture is any motion made by a user that makes contact with any object or surface. The surface can be a surface not having a touch sensor, a surface having a touch sensor, or a surface on the user's body and/or clothing. Here a touch sensor is any device that provides a signal responsive to touch. Surfaces can be any surface of a user's surroundings, body, or surfaces of objects a user may be holding. For example, a user carrying a passive haptic object should be able to perform a tap gesture on the passive prop and have the gesture correctly identified. In another example, a user should be able to depress a haptic button on a passive object and have the gesture correctly identified. Touch gestures can be distinguished from each other by one or more characteristics such as: gesture pattern, part of the user's body performing the gesture, touch duration, touch location, touch directionality, and touch force. Suitable gesture patterns include: tap, double tap, press, hold, directional swipe, directional scroll, directional rotation, pinch, and zoom. More specific touch gesture examples include:
1) A finger tap with a middle finger at a particular location on a passive surface. Specific types of tap gestures may be identified in applications such as keystroke input on a passive surface;
2) A directional finger swipe to the right with a right pointer finger on a surface equipped with a touch sensor;
3) A tap gesture with a right thumb on a passive cylindrical object.

In some examples, user touch gestures corresponding to typing on a keyboard can be acquired during normal typing on a keyboard and used to train a statistical model which is then deployed for operational detection of tap events on a passive surface. In some examples, user touch gestures corresponding to interaction with a touch-sensitive surface can be acquired during normal interaction with a touch-sensitive surface and used to train a statistical model which is then deployed for operational detection of surface interactions on a passive surface.

User motions can also be contractions and extensions of particular muscle or tendon groups.

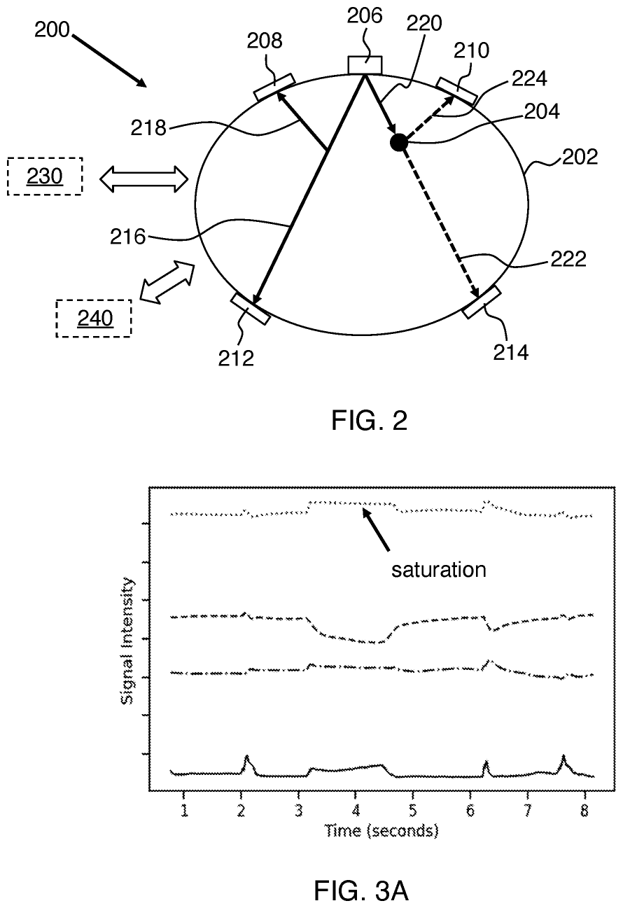

FIG. 2 illustrates exemplary optical paths through a user's body. Input light (e.g., 220) is directed towards the user's body 202 from a source (e.g., 206) and an optical path is formed which extends into the user's tissue. One or more interactions may occur between the light and the user's tissue along such an optical path—namely reflection, refraction, scattering (e.g., 218, 224), diffraction, polarization, and absorption. Light which does not undergo any of these processes can be considered as transmitted light (e.g., 216, 222). The extent to which these processes occur depend on the internal composition of the user's tissue in the optical path and the properties of the input light. Receivers 208, 210, 212, 214 receive the output light from the user's body. The example of FIG. 2 shows a single source and four receivers, but any number of sources and received can be used. Also, as indicated below, time division multiplexing can be used with a spatially fixed configuration of sources and receivers to increase the diversity of sampled optical paths.

In this work, the properties of the input light and methods of sampling the output light are selected such that the optical path may be sensitively and selectively perturbed by changes in the user's tissue made by user motions. For example, selecting a different wavelength, angle, polarization of the input light, emission half-angle, or a different distance between the input light location and the location at which the output light is sampled will result in a different optical path which penetrates to different depths in the user's body and is sensitive to different compositional changes in the user's tissue.

In some embodiments, the source of input light may be one or more light emitting diodes or laser diodes. In some embodiments, the input light may be configured to alter its location or angle to sample different optical paths. In some embodiments, sensors of the output light may be configured to alter their location or angle to sample different optical paths.

In one example, input light with a wavelength in the skin's near-infrared window may be selected, and output light may be sampled farther than 2 cm away from the input light location on the user's tissue to sample optical paths which reach farther into the user's tissue and are perturbed by motion of deeper structures including vasculature (e.g., vein 204), bones, muscles, or tendons during a user motion. In other examples, the output light location might be placed nearer to the input light location to receive an increased light intensity due to the shorter optical path. For multiple wavelengths of light including near-infrared light of wavelength 650 nm-1100 nm, an increase in the amount of hemoglobin and erythrocytes in an optical path extending into the user's body induces a decrease in the output light signal intensity due to increased absorption and scattering by erythrocytes along the optical path. In some cases, this fact can be exploited to provide an estimate of the amount of pressure being applied to the user's tissue by computing the blood volume in the user's capillary bed along the optical path. This may be done by modeling the user's tissue response with a combination of collected data and an optical model of the skin.

Optionally, one or more additional sensor modalities for data acquisition, user motion training and/or user motion identification can be used, as schematically indicated by 230 on FIG. 2. Such additional sensor modalities can be: cameras, laser interferometers, ultrasonic sensors, electromagnetic field sensors, GPS sensors, accelerometers, gyroscopes, magnetometers, temperature sensors, microphones, strain gauges, pressure sensors, capacitive touch sensors, impedance sensors, conductance sensors, capacitive electromyography sensors, and conductive electromyography sensors. Some embodiments of the device perform sensor fusion of optical and non-optical data to improve performance. For example, preprocessed optical data can be combined with acceleration and gyroscopic data through a trained statistical model or an algorithm to output the user's muscle activation state, intended control output, predicted gesture, gesture location, gesture orientation, gesture directionality, etc. In some embodiments, one or more of these sensors are used to compute the 6 degree-of-freedom spatial location of a user's body part in relation to the local space.

Optionally, the method can further include transmitting communication data to an external device (e.g., 240 on FIG. 2). Such communication data can include: input light signals, output light signals, preprocessed signals, and user motion identification results.

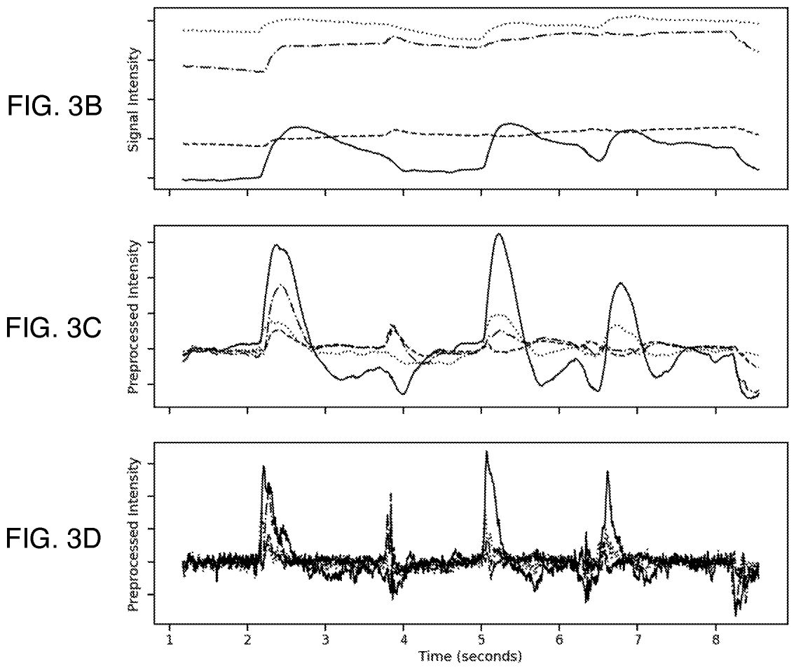

FIGS. 3A-3D illustrate the effect of preprocessing the output light signals. The response in the raw signal can be further modified through one or more preprocessing steps. The preprocessing steps remove the baseline and extract significant features for use as inputs to a trained statistical model which is then used for identification of user motions. FIG. 3A illustrates output light signals with no preprocessing or baseline adjustment. This naïve approach results in signal crosstalk and scaling issues as shown in FIG. 3A. FIG. 3B illustrates a time series of output light signals for one possible method utilizing active baseline adjustment as a function of the optical path, output light intensity, and/or the current baseline. This adjustment may be carried out by adjusting the intensity of the input light or the sensitivity of the sensor hardware sampling the output light. In some embodiments, the output light signals are automatically preprocessed by subtracting an ambient light signal from the output light signal generated by the input light to reduce the effect of ambient light intensity.

FIGS. 3C-D illustrate timeseries plots of preprocessed light signals where the preprocessing includes real-time removal of signal baselines. In FIG. 3C, baselines are computed as the average of the past fifteen milliseconds of output light data. In FIG. 3D, baselines are computed as the average of the past one second of output light data. Suppression of baselines by subtracting the average of the last 1 millisecond of data captures baselines at the shortest typical timescales of human motion, whereas subtracting the average of the last 10 seconds of data captures baselines at the longest timescales of typical human motion. One or more of these may be desirable to deliver different signal features to the statistical model and reduce errors caused by signal drift or spikes at different timescales.

In some embodiments, the real-time baseline suppression during operation is performed by subtraction of another output light signal.

In some embodiments, the preprocessing may include independent component analysis, where independent source signals are computed from a plurality of output light signals.

In some embodiments, the preprocessing may include calculating the pressure on the user's skin by using the output light signal to estimate the amount of blood along the optical path, which is affected by pressure on the skin.

In some embodiments, the trained statistical model utilizes one or more convolutional kernels which are convolved with the preprocessed light signals and/or downstream features which have been processed by the statistical model in the process of identifying user motions from timeseries data.

In some embodiments, the trained statistical model utilizes a self-attention mechanism, such as in a Transformer-based neural network.

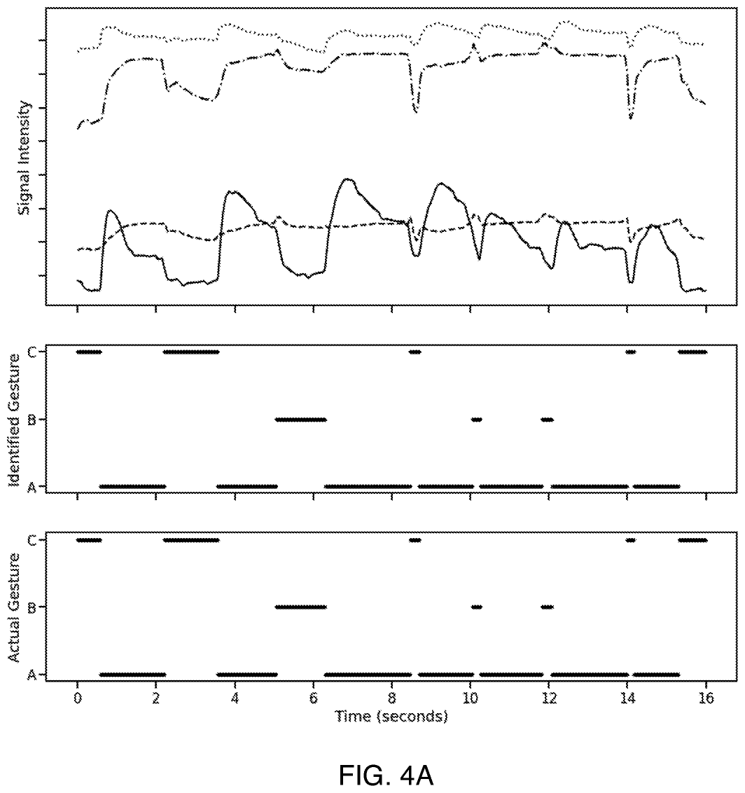

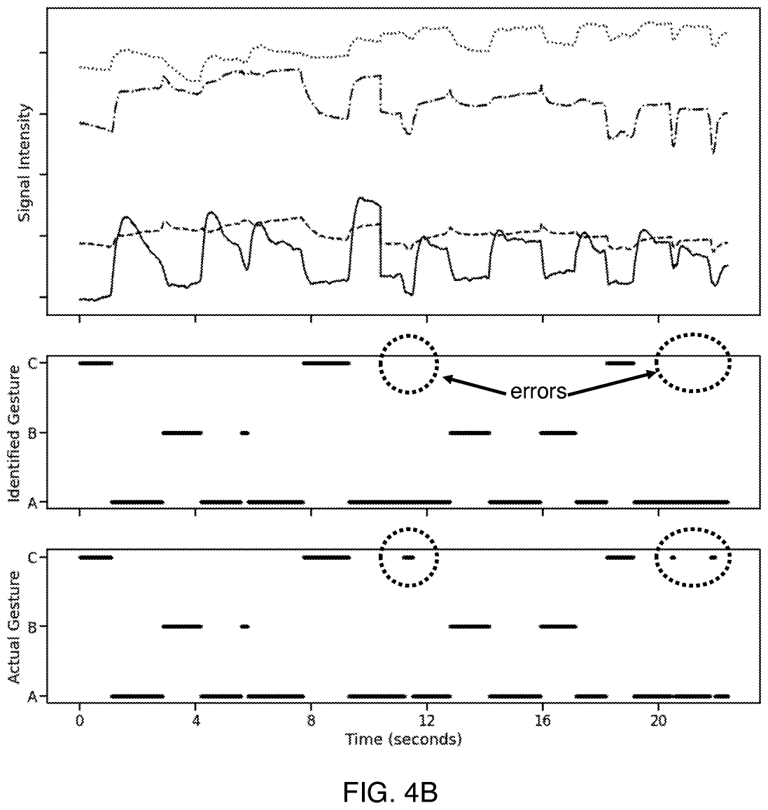

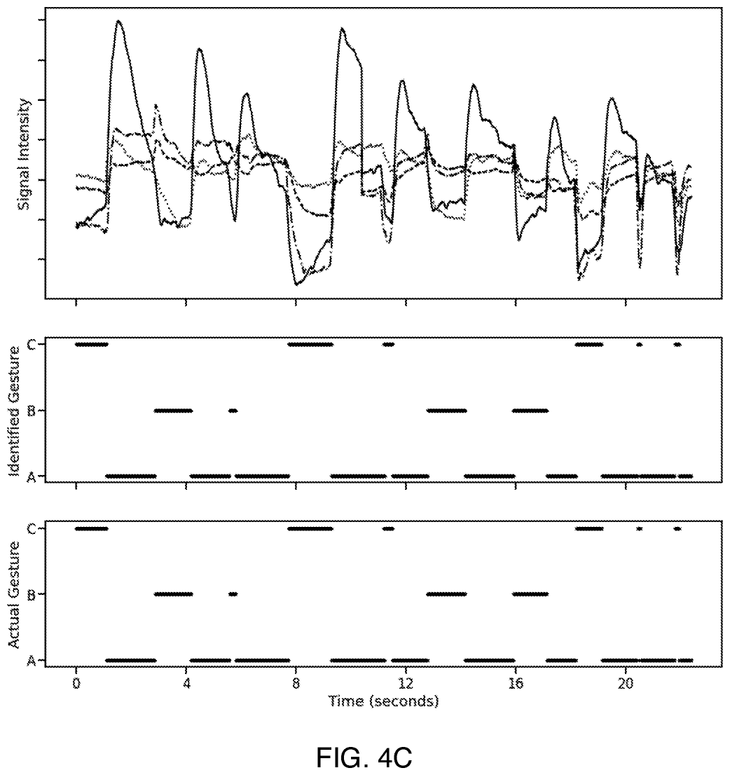

FIGS. 4A-C are plots of light signals which illustrate output light signals and their representative gesture identification results from a trained statistical model. FIGS. 4A-4B are plots of an output light signal which has not undergone real-time baseline removal. In FIG. 4A, a trained statistical model which has been trained on output light data from the same exact configuration of the input light, optical paths, and output light is able to correctly identify user motions. However, in FIG. 4B, the same statistical model is shown to provide inaccurate user motion identification when the configuration of the optical paths changes slightly, indicating that the model is not robust.

FIG. 4C is a plot of preprocessed light signals where baselines are suppressed as operational signals are acquired. Baseline suppression enables training and operational use of an improved statistical model which retains robust real-time gesture identification performance from the operational preprocessed signals for different configurations of the optical paths, such as in the case when the input and output light locations shift relative to a user's body part. Improved gesture identification is thereby provided.

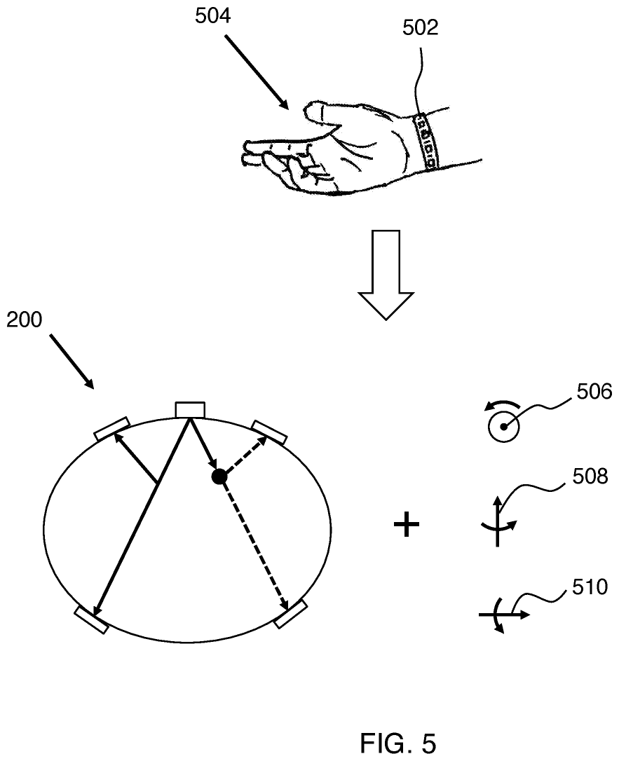

FIG. 5 illustrates an example of a wearable device, namely a wristband 502 for identifying motions of a user's hand 504. Here one or more optical sources and one or more optical detectors are disposed on a wearable device worn by the user, where the optical sources emit the input light, and where the optical detectors receive the output light. FIG. 2 shows an example of such a source +detector configuration. Each distinguishable optical path may be identified as a signal channel for further processing. In some embodiments, the wearable device is worn on the user's hand, wrist, or forearm, and detects motions of the user's hand and/or arm. Thus the part of the user's body can be the user's wrist, where the user motions being identified are finger and/or hand gestures. A wearable device can also be used on any other part of the user's body suitable for making motions to be identified. In one example, the wearable device is used on the user's leg, and the motions being identified are footsteps.

In some embodiments, the wearable device includes one or more other sensors to provide additional data channels, such as gyroscope readings 506, 508, and 510.

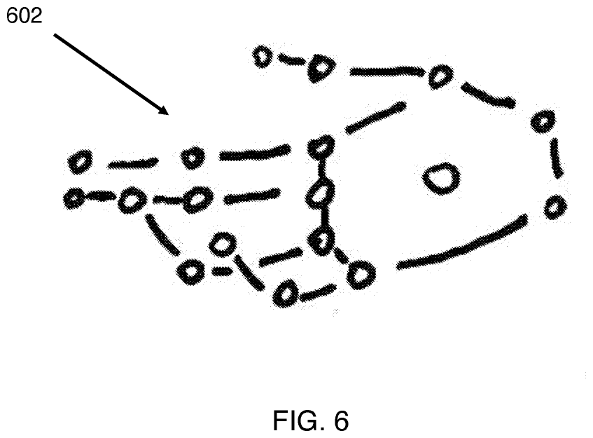

In some embodiments, a user's hand pose can be included in the hand gestures. One interpretation for hand pose is schematically shown in FIG. 6. This figure illustrates an exemplary hand pose which may be interpreted as a continuous gesture, wherein the hand pose corresponds to a gesture pattern which may be parameterized as a vector. In such cases, a hand pose can be defined as an articulated representation of one or more skeletal joints (i.e., the circles on FIG. 6) of the hand and wrist which describes their representative joint angles, optionally providing muscle activation intensities, and/or a confidence metric on the accuracy of the joint angle estimation and the muscle activation intensities. A hand pose may be described in one or more frames of reference. For example, a wrist rotation relative to a user's elbow may be measured and transmitted distinctly from a wrist rotation relative to the gravity vector. The articulated representation of the skeletal joints of the hand and wrist may be of high or low complexity, depending on the intended application.

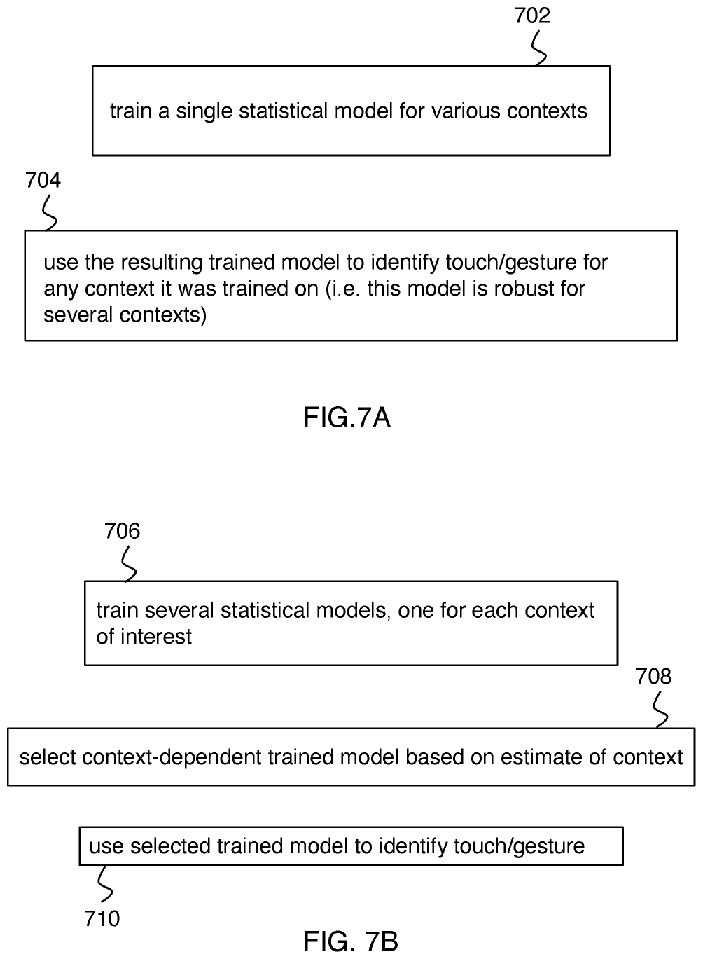

Optionally, contextual data can be used to aid in identification of user motions. Such contextual data can include a classification of a hand state of the user, such as: free, grasping an object and touching a surface. FIGS. 7A-B show two options for making use of such contextual data. In the approach of FIG. 7A, step 702 shows a single model being trained in various contexts. In step 704, the resulting model is robust in operation for the contexts it was trained on. This approach has the benefit of not requiring an explicit recognition of the context.

In the approach of FIG. 7B, step 706 is training several models, one for each context of interest. Step 708 is selecting a model to use for operational user motion recognition based on the estimated context. Step 710 is recognizing user motions using the selected model.

In one example, a user's hand is classified as resting on a surface, and a statistical model is selected such that surface touch gestures of tap, double tap, hold, directional swipe, directional scroll, pinch, zoom, and directional rotate can be identified by the trained model. In another example, a user's two hands are classified as resting on a surface, and a statistical model is selected such that the surface gesture patterns corresponding to typing on a keyboard are identified.

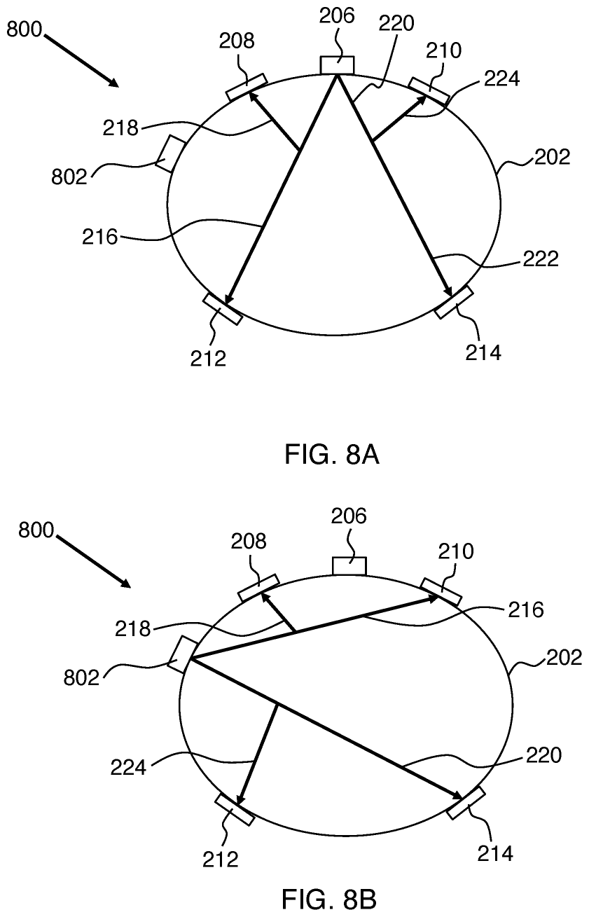

Time-division multiplexing can be used to sample two or more optical paths in the user's body using common source and/or detector hardware. FIGS. 8A-B show an example where a source 802 is added to the configuration of FIG. 2. FIG. 8A shows the resulting optical paths when only source 206 is active, and FIG. 8B shows the resulting optical paths when only source 802 is active. By time-interleaving the periods when only source 802 is active with the time periods when only source 206 is active, time-division multiplexing is achieved.

With this approach a single microcontroller may be used to drive a plurality of emitters and sensors and thereby generate a plurality of optical paths. In one example, a transistor switch may be used to connect drive circuitry to a first set of optical emitters, a second set of optical emitters, a third set of optical emitters, or a set of non-optical emitters. Similarly, a transistor switch may be used to connect signal conditioning circuitry, amplification circuitry and/or analog-to-digital-conversion circuitry to a first set of optical sensors, a second set of optical sensors, a third set of optical sensors, or a set of non-optical sensors. One or more of the possible emitter-sensor combinations may be used to generate signal channels, with multiplexing allowing for an increased number of possible combinations for a given set of shared circuitry.

In some embodiments, certain low-power optical channels are active in a low-power mode, and detection of a particular change in the preprocessed light value causes one or more additional channels to activate for more accurate user motion identification at the expense of higher power consumption.

In a naive implementation of an optical system for detecting user motion which utilizes shared circuitry which is at times connected to different sets of optical emitters and/or sensors, the received signal intensity for each channel is strongly dependent on the configuration of the emitters and sensors. Channels for which the input light follows a short optical path or one with low levels of absorbance may have a higher mean intensity, whereas channels for which the input light follows a longer optical path or one with higher levels of absorbance may have a much lower mean intensity. This is undesirable for signal processing, as this may cause differences in signal-to-noise ratio.

In such a naive implementation of an optical system, signal crosstalk and instability can also occur, such as when one or more of the optical devices or amplifiers reaches a saturation limit. If one or more optical sensors and/or emitters are shared between the high-intensity and low-intensity channels, this may result in a situation where a higher input light intensity is desirable for channels with a longer optical path, but increasing the input light intensity may result in saturation of a channel with a shorter optical path, thereby causing signal crosstalk and reducing system robustness.

Suppression of baselines as operational signals are acquired and/or real time adjustment of optical intensities as described above have been found to be effective solutions to problems encountered in such naive implementations.

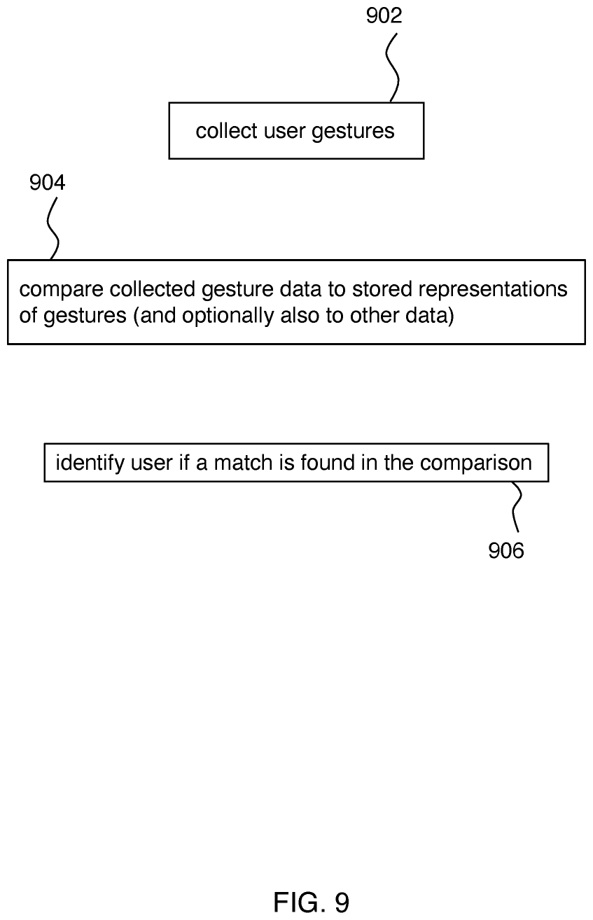

Some embodiments further include identifying the user by comparing the preprocessed operational signals to one or more stored representations of preprocessed training or operational signals. Here one or more of the stored representations of preprocessed training or operational signals are associated with particular user motions. FIG. 9 shows an example of this. Here step 902 is collecting user gestures. Step 904 is comparing collected gesture state to stored representations of gestures (and optionally to other data). Step 906 is identifying the user if a match is found.

In one example, output light signals generated during user motion may be stored in a memory storage device. These output light signals may be preprocessed by various means including baseline identification, baseline suppression, principal component analysis, independent component analysis, etc. Then at one or more future timepoints, operational output light signals are collected from a user and compared to the stored signals. In some embodiments, the stored and/or operational output light signals correspond to a particular set of user motions which are sequentially or simultaneously performed as a passphrase. In some embodiments, the combination of the sequential or simultaneous user motions and their accompanying output light signal forms a unique biometric identifier for the user. In some embodiments, a user is identified periodically by acquiring data and comparing the preprocessed data to stored representations of the same gesture from the same user. In some embodiments, the stored representations of user motions form a basis for a vector space, into which operational user motions can be projected to compare against stored representations and identify a user. In some embodiments, clustering algorithms such as principal component analysis and k-nearest-neighbors are used to identify a user from their natural movements. In some embodiments, the stored representations of output light signals associated with user motions forms a unique biometric signature of a user which can be used to selectively and accurately identify a user. In some embodiments, identification of a user will result in unlocking of an electronic device. In some embodiments, identification of a user will result in wireless transmission of a key to unlock a secondary electronic device.

1. A method of identifying user motions performed by a user, the method comprising:
directing input light toward a part of the user's body;
receiving output light that is caused by the input light from the part of the user's body, wherein an optical path from the input light to the output light extends into the user's body;
automatically preprocessing one or more training output light signals with a training preprocessing method to generate corresponding preprocessed training signals, wherein the training preprocessing method includes baseline suppression;
training a statistical model to relate identified user motions to the preprocessed training signals to generate a trained model;
automatically preprocessing one or more operational output light signals with an operational preprocessing method to generate corresponding preprocessed operational signals, wherein the operational preprocessing method includes baseline suppression as data is acquired; and
automatically identifying user motions using the trained model and the preprocessed operational signals.

2. The method of claim 1, wherein the training preprocessing method and/or the operational preprocessing method includes subtracting a moving average to generate the preprocessed training and/or operational signal.

3. The method of claim 2, wherein the moving average of a signal at time t is computed by averaging the signal over a time range from t−Δt to t, where Δt is in a range from 1 millisecond to 10 seconds.

4. The method of claim 1, wherein the training preprocessing method and/or the operational preprocessing method includes subtracting a periodic waveform generated by the user's heartbeat.

5. The method of claim 1, further comprising time-division multiplexing to sample two or more optical paths in the user's body using common source and/or detector hardware.

6. The method of claim 1, wherein one or more receiver baselines are adjusted as data is received by modifying input light intensity and/or receiver sensitivity, based on one or more parameters selected from the group consisting of: optical path length, output light intensity, and computed baseline value.

7. The method of claim 1, wherein one or more of the user motions are free space gestures.

8. The method of claim 7, wherein the free space gestures are distinguished from each other by one or more characteristics selected from the group consisting of: gesture pattern, part of the user's body performing the gesture, duration, location, orientation, directionality, and muscle force.

9. The method of claim 1, wherein one or more of the user motions are touch gestures made by touching a surface.

10. The method of claim 9, wherein the touch gestures are distinguished from each other by one or more characteristics selected from the group consisting of: gesture pattern, part of the user's body performing the gesture, touch duration, touch location, touch directionality, and touch force.

11. The method of claim 10, wherein the gesture pattern is selected from the group consisting of: tap, double tap, press, hold, directional swipe, directional scroll, directional rotation, pinch, and zoom.

12. The method of claim 9, wherein the surface is selected from the group consisting of: surfaces not having a touch sensor, surfaces having a touch sensor, and surfaces on the user's body and/or clothing.

13. The method of claim 1, wherein the part of the user's body is the user's wrist, and wherein the user motions being identified are finger and/or hand gestures.

14. The method of claim 13, further comprising use of contextual data to aid in identification of user motions, wherein the contextual data includes a classification of a hand state of the user selected from the group consisting of: free, grasping an object and touching a surface.

15. The method of claim 13, wherein a hand pose of the user is included in the hand gestures.

16. The method of claim 1, wherein one or more optical sources and one or more optical detectors are disposed on a wearable device worn by the user, wherein the optical sources emit the input light, and wherein the optical detectors receive the output light.

17. The method of claim 1, further comprising adding one or more additional sensor modalities for data acquisition, user motion training and/or user motion identification, wherein the additional sensor modalities are selected from the group consisting of: cameras, laser interferometers, ultrasonic sensors, electromagnetic field sensors, GPS sensors, accelerometers, gyroscopes, magnetometers, temperature sensors, microphones, strain gauges, pressure sensors, capacitive touch sensors, impedance sensors, conductance sensors, capacitive electromyography sensors, and conductive electromyography sensors.

18. The method of claim 1, further comprising automatically providing feedback to the user after identification of a user motion done by the user.

19. The method of claim 1, further comprising selecting and executing a command in a software system after identification of a user motion done by the user, wherein the command that is selected depends on user motion identification.

20. The method of claim 1, further comprising transmitting communication data to an external device, wherein the communication data includes one or more items selected from the group consisting of: input light signals, output light signals, preprocessed training signals, preprocessed operational signals, and user motion identification results.

21. The method of claim 1, further comprising identifying the user by comparing the preprocessed operational signals to one or more stored representations of preprocessed training or operational signals, wherein one or more of the stored representations of preprocessed training or operational signals are associated with particular user motions.

22. The method of claim 1, further comprising adding a perturbation to the training output light signals prior to the training the statistical model to improve robustness of the trained model, wherein the perturbation is selected from the group consisting of: additive noise and signal amplitude modulation.
